SEQUENCE LISTING (8 sequences)

SEQ ID NO: 1 - DNA, 24 bp, synthetic construct
  misc_feature 1..24: note = Primer
  source 1..24: mol_type = other DNA
aggaggagtctgcggcacattagc

SEQ ID NO: 2 - DNA, 22 bp, synthetic construct
  misc_feature 1..22: note = Primer
  source 1..22: mol_type = other DNA
tccccactgctgcctcccgtag

SEQ ID NO: 3 - DNA, 19 bp, synthetic construct
  misc_feature 1..19: note = Primer
  source 1..19: mol_type = other DNA
tacchraggaggaagccac

SEQ ID NO: 4 - DNA, 22 bp, synthetic construct
  misc_feature 1..22: note = Primer
  source 1..22: mol_type = other DNA
gttcttcctaatctctacgcat

SEQ ID NO: 5 - DNA, 17 bp, synthetic construct
  misc_feature 1..17: note = Primer
  source 1..17: mol_type = other DNA
acgctacttgaggagga

SEQ ID NO: 6 - DNA, 18 bp, synthetic construct
  misc_feature 1..18: note = Primer
  source 1..18: mol_type = other DNA
gagccgtagcctttcact

SEQ ID NO: 7 - DNA, 19 bp, synthetic construct
  misc_feature 1..19: note = Primer
  source 1..19: mol_type = other DNA
cggtaattccagctccaat

SEQ ID NO: 8 - DNA, 20 bp, synthetic construct
  misc_feature 1..20: note = Primer
  source 1..20: mol_type = other DNA
tcgatcccctaactttcgtt

(19) United States
(12) Patent Application Publication
(10) Pub. No.: US 2026/0150862 A1
(43) Pub. Date: Jun. 4, 2026

(54) GUT BACTERIUM-BASED TREATMENT TO INCREASE POULTRY GUT HEALTH AND FOOD SAFETY

(71) Applicant: Iowa State University Research Foundation, Inc., Ames, IA (US)

(72) Inventors: Melha Mellata, Ames, IA (US); Graham Redweik, Ames, IA (US)

(21) Appl. No.: 19/399,349

(22) Filed: Nov. 24, 2025

Related U.S. Application Data
(63) Continuation of application No. 17/248,597, filed on Jan. 29, 2021, now abandoned.
(60) Provisional application No. 62/968,294, filed on Jan. 31, 2020.

(51) Int. Cl. A23K 10/18; A23K 20/22; A23K 50/75

(52) U.S. Cl. CPC A23K 10/18; A23K 20/22; A23K 50/75

(57) ABSTRACT

The present invention relates to probiotic compositions and methods of using such compositions. In particular, the present invention provides methods of using segmented filamentous bacteria to improve gastrointestinal health, reduce bacterial pathogens, and stimulate host immune function in poultry.

### CROSS REFERENCE TO RELATED APPLICATIONS

This application is a Continuation application of U.S. Ser. No. 17/248,597, filed Jan. 29, 2021, which claims priority under 35 U.S.C. § 119 to provisional application U.S. Ser. No. 62/968,294, filed Jan. 31, 2020, both of which are incorporated herein by reference in their entirety.

### SEQUENCE LISTING

A sequence listing contained in the file named P13153US02.xml which is 11,087 bytes in size (measured in MS-Windows), which was created on Nov. 24, 2025, and which comprises 8 sequences, is electronically filed herewith and is incorporated herein by reference in its entirety.

### TECHNICAL FIELD

This invention relates to probiotic compositions of segmented filamentous bacteria (SFB) for improving gastrointestinal health, reducing bacterial pathogens, and stimulating host immune function in poultry.

### BACKGROUND

The intestinal tract is considered the central site for optimizing health and performance of production in animals. In chickens, this complex tissue system must absorb nutrients to energize functions like growth and egg production while simultaneously serve as a barrier to pathogenic bacteria like Salmonella. Thus, interventions at the gastrointestinal tract are imperative for maximizing health and production potential. Commercial poultry practices have led to genetic selection of chickens to maximize their respective production functions (i.e., layers versus broilers). Additionally, supplements like probiotics need to be given to poultry animals to further maximize feed efficiency and pathogen resistance. Current probiotics require continuous addition in feed to maintain their effects and can even serve as a potential reservoir for antibiotic resistance. Thus, a more cost-effective probiotic without these limitations would benefit the poultry industry.

Segmented filamentous bacteria (SFB), otherwise known as Candidatus Savagella are gut bacteria widely distributed among animals. Although SFB are present in several animal species, including humans, mice, and chickens, they are host-specific, as SFB from one animal have not been demonstrated to colonize another. In mice, SFB directly attach to the epithelium without damaging the gut barrier nor causing excessive inflammation. A well-studied characteristic of murine SFB is their immunostimulatory activity. This intimate colonization of intestinal epithelium enables potent stimulation of the immune system, promoting T cell differentiation that improves epithelial barrier functions and resistance to enteric infections. The limited work on poultry SFB demonstrate they colonize the distal ileum, ceca tonsil and loops and are associated with improved antibody production and growth performance. However, there has been no experimental attempt to study SFB in poultry and evaluate their broad immune activation.

### SUMMARY

Segmented filamentous bacteria (SFB) are a keystone taxon that intimately bind to the animal intestine. In chickens, SFB naturally reach peak colonization by fourteen days post-hatch, but its colonization is not consistent between animals. The compositions and methods of the present invention can be employed to hasten SFB gut colonization and improve the intestinal health of animals such as birds and poultry, especially chickens. SFB strains exhibit extreme host-specificity, reducing the possibility of zoonosis from poultry to humans. Additionally, given its minimal genome, SFB have a reduced capability to harbor plasmids, reducing the risk of SFB as a reservoir for antibiotic resistance genes.

In an embodiment, the present invention provides methods of improving intestinal health and/or inducing resistance to bacterial pathogens in poultry. The methods comprise administering to the poultry an effective amount of a probiotic composition comprising viable spores of a segmented filamentous bacteria (SFB). The use of the probiotic compositions described herein for poultry result in reduced colonization of the gastrointestinal tracts of poultry by bacterial pathogens, including but not limited to Salmonella spp., Campylobacter spp., and Clostridium spp. In one embodiment, the Salmonella is Salmonella Enteritidis, Salmonella Typhimurium, Salmonella Heidelberg, Salmonella Kentucky, or any combination thereof. In another embodiment, the Campylobacter is Campylobacter jejuni, Campylobacter coli, or any combination thereof. In another embodiment, the Clostridium is Clostridium perfringens. The use of the probiotic compositions described herein lower gut permeability and reduce microbial leakage from the gastrointestinal tract, further providing for a reduced risk of extraintestinal pathogens including for bacterial sepsis from pathogens like Escherichia coli.

In some embodiments, the effective amount is from about 10 to about 200 spores, preferably from about 50 to about 100 spores. Preferably, the probiotic composition is administered orally. Preferably, the probiotic composition is administered within 24 hours of hatching. Preferably, the probiotic composition is a single-use probiotic. The probiotic composition is provided once and exerts beneficial effects up to at least 14 days. In some embodiments, the methods further comprise administering sodium bicarbonate prior to the probiotic composition to reduce pH and improve colonization.

In an embodiment, the invention provides probiotic compositions for use in poultry, especially chickens, comprising viable spores of a segmented filamentous bacteria (SFB) and an agriculturally acceptable excipient. Preferably, the SFB is host-specific for chickens. In some embodiments, the compositions comprise from about 10 to about 200 spores, preferably from about 50 to about 100 spores. Preferably, the spores are derived from a small intestinal scraping. Preferably, the small intestinal scraping is chloroform-treated. In some embodiments, the compositions further comprise sodium bicarbonate.

In another embodiment, the invention relates to methods of preparing probiotic compositions from poultry, especially chickens. The methods comprise obtaining a small intestinal scraping sample from poultry, treating the sample with chloroform, and isolating segmented filamentous bacteria (SFB) spores from the chloroform treated sample. In some embodiments, the methods further comprise freezing the isolated SFB spores for long term storage.

The invention further provides poultry feeds comprising the probiotic compositions disclosed herein. In yet a further embodiment, the invention provides kits comprising the probiotic compositions disclosed herein. Preferably, the kits include sodium bicarbonate.

While multiple embodiments are disclosed, still other embodiments of the present invention will become apparent to those skilled in the art from the following detailed description, which shows and describes illustrative embodiments of the invention.

Accordingly, the figures and detailed description are to be regarded as illustrative in nature and not restrictive.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1A and FIG. 1B show polymerase chain reaction (PCR)-based screening for microbes in small intestinal scrapings with SFB (iSFB) and control (CON) inocula. Microbes were screened in inocula using SFB, Clostridium Clusters I (ClostI) and XI (ClostXI), and universal eukaryote (Euk) primers. The E. coli strain MG1655 was used as a negative-control. Primers are summarized in TABLE 1.

FIG. 2A-F show transmission electron microscope (TEM) images of bacterial spores in iSFB and CON inocula. FIG. 2A and FIG. 2B show CON inoculum. FIG. 2C-F show iSFB inoculum.

FIG. 3A-F show scanning electron microscope (SEM) detection of SFB in distal ileum. SEM images were taken for CON and iSFB birds at multiple days post-inoculation (dpi) to track SFB colonization over time. FIG. 3A shows CON, 3 dpi. FIG. 3B shows CON, 7 dpi. FIG. 3C shows CON, 14 dpi. FIG. 3D shows iSFB, 3 dpi. FIG. 3E shows iSFB, 7 dpi. FIG. 3F shows iSFB, 14 dpi.

FIG. 4 shows PCR detection of SFB in ceca content. SFB-specific primers were used to detect SFB in ceca content at 3, 7, and 14 dpi time points. Primers are summarized in TABLE 1.

FIG. 5A-C show measures of weight gain and gut morphology. FIG. 5A shows chick weight measured at 1 and 11 days post-hatch to assess average weight gain per animal. FIG. 5B shows intestinal segment lengths measured via ruler at 14 days post-inoculation (dpi). FIG. 5C shows gut permeability measured at 3 dpi via orally-delivered fluorescein isothiocyanate dextran (FITC)-dextran leakage in serum. *, P<0.05. **, P<0.01.

FIG. 6A-C shows Salmonella resistance assays in vitro. Salmonella enterica resistance was measured using in vitro bactericidal assays against multiple Salmonella isolates (summarized in TABLE 2). Salmonella killing was performed in small intestinal scrapings in experimental duplicate. *, P<0.05. **, P<0.01. ***, P<0.001. ****, P<0.0001.

FIG. 7 shows total IgA production. Endpoint titers for total IgA were measured in small intestinal scrapings from birds at 3, 7, and 14 days post-inoculation (dpi) via enzyme-linked immunosorbent assay (ELISA). Assays were performed in experimental duplicate. ****, P<0.0001.

### DETAILED DESCRIPTION

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

Numeric ranges recited within the specification, including ranges of “greater than,” “at least”, or “less than” a numeric value, are inclusive of the numbers defining the range and include each integer within the defined range. For example, when a range of “1 to 5” is recited, the recited range should be construed as including ranges “1 to 4”, “1 to 3”, “1-2”, “1-2 & 4-5”, “1-3 & 5”, and the like.

The singular terms “a”, “an”, and “the” include plural referents unless context clearly indicates otherwise. Similarly, the word “or” is intended to include “and” unless the context clearly indicate otherwise. The word “or” means any one member of a particular list and also includes any combination of members of that list.

The term “about” as used herein, refers to variation in the numerical quantity that can occur, for example, through typical measuring techniques and equipment, with respect to any quantifiable variable, including, but not limited to, mass, volume, and time. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The terms “administering”, “administration” and the like as used herein are intended to encompass any active or passive administration of the probiotic composition to the gastrointestinal tract of an animal by a chosen route. Such routes of administration may include, for example, oral administration, but without limitation thereto. The probiotic composition may be administered by any method known in the art, including those described herein.

As used herein the term “agriculturally acceptable excipient” is a natural or synthetic substance formulated alongside the active ingredient of a formulation included for the purpose of long-term stabilization, bulking up solid formulations that contain potent active ingredients, or to confer a therapeutic enhancement on the active ingredient in the final dosage form, such as facilitating absorption, reducing viscosity, increasing viscosity, or enhancing solubility.

The terms “effective amount” or “therapeutically effective amount” describes a quantity of a probiotic composition sufficient to achieve a desired effect in the animal being treated with that probiotic composition. For example, this can be the amount of a probiotic composition comprising segmented filamentous bacteria necessary to prevent and/or treat a disease, disorder or condition capable of being prevented and/or treated, at least in part, by a probiotic.

The term “intestinal microbiota”, as used herein, refers to the population of microorganisms inhabiting the gastrointestinal tract.

The term “isolated” refers to a material that is substantially or essentially free from components that normally accompany it in its native state. For example, isolated SFB spores may refer to SFB spores that have been purified or removed from naturally or non-naturally occurring components that are present in its naturally occurring environment.

The term “microbiome”, as used herein, refers to a population of microorganisms from a particular environment, including the environment of the body or a part of the body. The term is interchangeably used to address the population of microorganisms itself (sometimes referred to as the microbiota), as well as the collective genomes of the microorganisms that reside in the particular environment.

As used herein the term “poultry” relates to the class of domesticated fowl (birds) used for food or for their eggs. Poultry includes wildfowl, waterfowl, and game birds. Examples of poultry include, but are not limited to, chicken, broilers, bantams, turkey, duck, geese, guinea fowl, peafowl, quail, dove, pigeon (squab), and pheasant.

The term “primer” as used herein refers to an oligonucleotide which is capable of annealing to the amplification target allowing a DNA polymerase to attach, thereby serving as a point of initiation of DNA synthesis when placed under conditions in which synthesis of primer extension product is induced, i.e., in the presence of nucleotides and an agent for polymerization such as DNA polymerase and at a suitable temperature and pH. The (amplification) primer is preferably single stranded for maximum efficiency in amplification. Preferably, the primer is an oligodeoxyribonucleotide. The primer must be sufficiently long to prime the synthesis of extension products in the presence of the agent for polymerization. The exact lengths of the primers will depend on many factors, including temperature and composition (A/T vs. G/C content) of primer. A pair of bi-directional primers consists of one forward and one reverse primer as commonly used in the art of DNA amplification such as in PCR amplification.

The term “probiotic” is used to refer to live, non-pathogenic microorganisms, e.g., bacteria, which can confer health benefits to a host organism that contains an appropriate amount of the microorganism.

As used herein, “spore” or “spores” refer to structures produced by bacteria that are adapted for survival and dispersal. Spores are generally characterized as dormant structures; however, spores are capable of differentiation through the process of germination. Germination is the differentiation of spores into vegetative cells that are capable of metabolic activity, growth, and reproduction. The germination of a single spore results in a single bacterial vegetative cell. Bacterial spores are structures for surviving conditions that may ordinarily be nonconductive to the survival or growth of vegetative cells.

### Compositions

The invention provides probiotic compositions comprising viable spores of segmented filamentous bacteria (SFB). In some aspects, the disclosure provides for utilizing SFB spores to impart one or more beneficial properties or improved traits to poultry production. In various aspects, the SFB spores may be formulated as a probiotic composition. The probiotic compositions can be employed to hasten SFB gut colonization and improve the intestinal health of animals such as birds and poultry, especially chickens.

The SFB spores may be derived from a small intestinal scraping. Preferably, the small intestinal scraping is chloroform-treated to induce sporulation.

In some embodiments, the probiotic composition comprises a total of, or at least, 10, 20, 30, 40, 50, 60, 70, 80, 90, 100, 200, 300, 400, 500, 1000, 5000, or 10000 SFB spores. In some embodiments, the probiotic composition comprises 10 to 10000, 50 to 10000, 100 to 10000, 500 to 10000, 1000 to 10000, 5000 to 10000, 10 to 5000, 50 to 5000, 100 to 5000, 500 to 5000, 1000 to 5000, 10 to 1000, 50 to 1000, 100 to 1000, 500 to 1000, 10 to 500, 50 to 500, 100 to 500, 10 to 200, 50 to 200, 100 to 200, 10 to 100, or 50 to 100 SFB spores.

In embodiments, the probiotic composition may be formulated as a dry powder, suspension, or solution. In embodiments, the probiotic composition formulated as a dry powder may be soluble in water. In embodiments, the probiotic composition formulated as a dry powder may be soluble in an organic solvent. In various aspects, the probiotic composition of the present disclosure may include an agriculturally acceptable excipient. In embodiments, the probiotic composition formulated as a dry powder may be directly added to an animal feed during processing and manufacturing.

In some embodiments, the probiotic compositions include poultry feed, such as cereals (barley, maize, oats, and the like); starches (tapioca and the like); oilseed cakes; and vegetable wastes. In some embodiments, the probiotic compositions include vitamins, minerals, trace elements, emulsifiers, aromatizing products, binders, colorants, odorants, thickening agents, and the like. In some embodiments, the probiotic compositions include one or more of an ionophore; vaccine; antibiotic; antihelmintic; virucide; nematicide; amino acids such as methionine, glycine, and arginine; fish oil; oregano; and biologically active molecules such as enzymes.

In some embodiments, the probiotic compositions of the present disclosure are solid. Where solid compositions are used, it may be desired to include one or more carrier materials including, but not limited to: mineral earths such as silicas, talc, kaolin, limestone, chalk, clay, dolomite, diatomaceous earth; calcium sulfate; magnesium sulfate; magnesium oxide; zeolites, calcium carbonate; magnesium carbonate; trehalose; chitosan; shellac; albumins; starch; skim-milk powder; sweet-whey powder; maltodextrin; lactose; inulin; dextrose; products of vegetable origin such as cereal meals, tree bark meal, wood meal, and nutshell meal.

In some embodiments, the probiotic compositions of the present disclosure are liquid. In further embodiments, the liquid comprises a solvent that may include water or an alcohol or a saline or carbohydrate solution, and other animal-safe solvents. In some embodiments, the probiotic compositions of the present disclosure include binders such as animal-safe polymers, carboxymethylcellulose, starch, polyvinyl alcohol, and the like.

In some embodiments, the probiotic compositions of the present disclosure comprise thickening agents such as silica, clay, natural extracts of seeds or seaweed, synthetic derivatives of cellulose, guar gum, locust bean gum, alginates, and methylcelluloses. In some embodiments, the probiotic compositions comprise anti-settling agents such as modified starches, polyvinyl alcohol, xanthan gum, and the like.

In some embodiments, the probiotic compositions of the present disclosure comprise colorants including organic chromophores classified as nitroso; nitro; azo, including monoazo, bisazo and polyazo; acridine, anthraquinone, azine, diphenylmethane, indamine, indophenol, methine, oxazine, phthalocyanine, thiazine, thiazole, triarylmethane, xanthene. In some embodiments, the probiotic compositions of the present disclosure comprise trace nutrients such as salts of iron, manganese, boron, copper, cobalt, molybdenum and zinc. In some embodiments, the probiotic compositions comprise dyes, both natural and artificial.

In some embodiments, the probiotic compositions of the present disclosure comprise an animal-safe virucide, bacteriocide, or nematicide.

In some embodiments, probiotic compositions of the present disclosure comprise saccharides (e.g., monosaccharides, disaccharides, trisaccharides, polysaccharides, oligosaccharides, and the like), polymeric saccharides, lipids, polymeric lipids, lipopolysaccharides, proteins, polymeric proteins, lipoproteins, nucleic acids, nucleic acid polymers, silica, inorganic salts and combinations thereof. In a further embodiment, probiotic compositions comprise polymers of agar, agarose, gelrite, and gellan gum, and the like. In some embodiments, probiotic compositions comprise plastic capsules, emulsions (e.g., water and oil), membranes, and artificial membranes. In some embodiments, emulsions or linked polymer solutions may comprise probiotic compositions of the present disclosure. See Harel and Bennett (U.S. Pat. No. 8,460,726B2).

In some embodiments, probiotic compositions of the present disclosure comprise one or more oxygen scavengers, denitrifiers, nitrifiers, heavy metal chelators, and/or dechlorinators; and combinations thereof. In one embodiment, the one or more oxygen scavengers, denitrifiers, nitrifiers, heavy metal chelators, and/or dechlorinators are not chemically active once the probiotic compositions are mixed with food and/or water to be administered to the fowl. In one embodiment, the one or more oxygen scavengers, denitrifiers, nitrifiers, heavy metal chelators, and/or dechlorinators are not chemically active when administered to the fowl.

In some embodiments, probiotic compositions of the present disclosure occur in a solid form (e.g., dispersed lyophilized spores) or a liquid form (spores interspersed in a storage medium). In some embodiments, probiotic compositions of the present disclosure are added in dry form to a liquid to form a suspension immediately prior to administration.

In some embodiments, probiotic compositions of the present disclosure comprise one or more preservatives. The preservatives may be in liquid or gas formulations. The preservatives may be selected from one or more of monosaccharide, disaccharide, trisaccharide, polysaccharide, acetic acid, ascorbic acid, calcium ascorbate, erythorbic acid, iso-ascorbic acid, erythrobic acid, potassium nitrate, sodium ascorbate, sodium erythorbate, sodium iso-ascorbate, sodium nitrate, sodium nitrite, nitrogen, benzoic acid, calcium sorbate, ethyl lauroyl arginate, methyl-p-hydroxy benzoate, methyl paraben, potassium acetate, potassium benzoiate, potassium bisulphite, potassium diacetate, potassium lactate, potassium metabisulphite, potassium sorbate, propyl-p-hydroxy benzoate, propyl paraben, sodium acetate, sodium benzoate, sodium bisulphite, sodium nitrite, sodium diacetate, sodium lactate, sodium metabisulphite, sodium salt of methyl-p-hydroxy benzoic acid, sodium salt of propyl-p-hydroxy benzoic acid, sodium sulphate, sodium sulfite, sodium dithionite, sulphurous acid, calcium propionate, dimethyl dicarbonate, natamycin, potassium sorbate, potassium bisulfite, potassium metabisulfite, propionic acid, sodium diacetate, sodium propionate, sodium sorbate, sorbic acid, ascorbic acid, ascorbyl palmitate, ascorbyl stearate, butylated hydro-xyanisole, butylated hydroxytoluene (BHT), butylated hydroxyl anisole (BHA), citric acid, citric acid esters of mono- and/or diglycerides, L-cysteine, L-cysteine hydrochloride, gum guaiacum, gum guaiac, lecithin, lecithin citrate, monoglyceride citrate, monoisopropyl citrate, propyl gallate, sodium metabisulphite, tartaric acid, tertiary butyl hydroquinone, stannous chloride, thiodipropionic acid, dilauryl thiodipropionate, distearyl thiodipropionate, ethoxyquin, sulfur dioxide, formic acid, or tocopherol(s).

In some embodiments, the probiotic compositions comprise sodium bicarbonate.

### Animal Feed

In some embodiments, compositions of the present disclosure are mixed with animal feed. In some embodiments, animal feed may be present in various forms such as pellets, capsules, granulated, powdered, mash, liquid, or semi-liquid.

In some embodiments, compositions of the present disclosure are mixed into the premix or mash at the feed mill, alone as a standalone premix, and/or alongside other feed additives. In one embodiment, the compositions of the present disclosure are mixed into or onto the feed at the feed mill. In another embodiment, compositions of the present disclosure are mixed into the feed itself.

In some embodiments, feed of the present disclosure may be supplemented with water, premix or premixes, forage, fodder, beans (e.g., whole, cracked, or ground), grains (e.g., whole, cracked, or ground), bean- or grain-based oils, bean- or grain-based meals, bean- or grain-based haylage or silage, bean- or grain-based syrups, fatty acids, sugar alcohols (e.g., polyhydric alcohols), commercially available formula feeds, oyster shells and those of other bivalves, and mixtures thereof.

In some embodiments, forage encompasses hay, haylage, and silage. In some embodiments, hays include grass hays (e.g., sudangrass, orchardgrass, or the like), alfalfa hay, and clover hay. In some embodiments, haylages include grass haylages, sorghum haylage, and alfalfa haylage. In some embodiments, silages include maize, oat, wheat, alfalfa, clover, and the like.

In some embodiments, premix or premixes may be utilized in the feed. Premixes may comprise micro-ingredients such as vitamins, minerals, amino acids; chemical preservatives; pharmaceutical compositions such as antibiotics and other medicaments; fermentation products, and other ingredients. In some embodiments, premixes are blended into the feed.

In some embodiments, the feed may include feed concentrates such as soybean hulls, soybean oils, sugar beet pulp, molasses, high protein soybean meal, ground corn, shelled corn, wheat midds, distiller grain, cottonseed hulls, and grease. See Anderson et al. (U.S. Pat. No. 3,484,243), Iritani et al. (U.S. Pat. No. 6,090,416), Axelrod et al. (U.S. Publication US20060127530A1), and Katsumi et al. (U.S. Pat. No. 5,741,508) for animal feed and animal feed supplements capable of use in the present compositions and methods.

In some embodiments, feed occurs as a compound, which includes, in a mixed composition capable of meeting the basic dietary needs, the feed itself, vitamins, minerals, amino acids, and other necessary components. Compound feed may further comprise premixes.

In some embodiments, probiotic compositions of the present disclosure may be mixed with animal feed, premix, and/or compound feed. Individual components of the animal feed may be mixed with the probiotic compositions prior to feeding to poultry. The probiotic compositions of the present disclosure may be applied into or on a premix, into or on a feed, and/or into or on a compound feed.

### Administration of Compositions

In some embodiments, the probiotic compositions of the present disclosure are administered to poultry via the oral route. In some embodiments the probiotic compositions are administered via a direct injection route into the gastrointestinal tract. In further embodiments, the direct injection administration delivers the probiotic compositions directly to one or more of the crop, gizzard, cecum, small intestine, and large intestine. In some embodiments, the probiotic compositions of the present disclosure are administered to animals through the cloaca. In further embodiments, cloacal administration is in the form of an inserted suppository.

In some embodiments, the probiotic compositions are administered through drinking water, spraying on litter in which the animal is in contact with, mixing with medications or vaccines, and gavage. In some embodiments, the probiotic compositions are sprayed directly on the animal, wherein the animal ingests the composition having been sprayed on the animal. In some embodiments, the probiotic compositions are sprayed on and/or sprayed in feed, and the feed is administered to the animal. In further embodiments, the animal ingests the composition through the preening of feathers that have come into contact with the sprayed composition.

In some embodiments, the probiotic compositions of the present disclosure are administered to poultry on day 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or 31 post-hatching. In some embodiments, the probiotic compositions are administered to the exterior surface of an egg as a liquid, semi-liquid, or solid on day 22, 21, 20, 19, 18, 17, 16, 15, 14, 13, 12, 11, 10, 9, 8, 7, 6, 5, 4, 3, 2, 1, or 0 pre-hatching. In some embodiments, the probiotic compositions of the present disclosure are administered to poultry in multiple dosing sessions in week(s) 1, 2, 3, 4, 5, 6, 7, 8, 9, 10, 11, 12, 13, 14, 15, 16, 17, 18, 19, 20, 21, 22, 23, 24, 25, 26, 27, 28, 29, and/or 30 week(s) post-hatching. In some embodiments, the probiotic composition is a single-use probiotic. In some embodiments, the probiotic compositions are administered immediately after hatching. In some embodiments, the probiotic compositions are administered within 1, 2, 3, 4, 5, 6, 7, 8, 9, 10, 11, 12, 13, 14, 15, 16, 17, 18, 19, 20, 21, 22, 23, or 24 hours of hatching. In some embodiments, the probiotic compositions are administered into the egg (e.g., injection) by itself or administered along with other products such as vaccines.

In some embodiments, the probiotic composition is administered in a dose comprising a total of, or at least, 10, 20, 30, 40, 50, 60, 70, 80, 90, 100, 200, 300, 400, 500, 1000, 5000, or 10000 SFB spores. In some embodiments, the administered dose of the probiotic composition comprises 10 to 10000, 50 to 10000, 100 to 10000, 500 to 10000, 1000 to 10000, 5000 to 10000, 10 to 5000, 50 to 5000, 100 to 5000, 500 to 5000, 1000 to 5000, 10 to 1000, 50 to 1000, 100 to 1000, 500 to 1000, 10 to 500, 50 to 500, 100 to 500, 10 to 200, 50 to 200, 100 to 200, 10 to 100, or 50 to 100 SFB spores.

In some embodiments, the feed can be uniformly coated with one or more layers of the probiotic compositions disclosed herein, using conventional methods of mixing, spraying, or a combination thereof through the use of treatment application equipment that is specifically designed and manufactured to accurately, safely, and efficiently apply coatings. Such equipment uses various types of coating technology such as rotary coaters, drum coaters, fluidized bed techniques, spouted beds, rotary mists, or a combination thereof. Liquid treatments such as those of the present disclosure can be applied via either a spinning “atomizer” disk or a spray nozzle, which evenly distributes the probiotic composition onto the feed as it moves though the spray pattern. In some aspects, the feed is then mixed or tumbled for an additional period of time to achieve additional treatment distribution and drying.

In some embodiments, the spores can be coated freely onto any number of compositions or they can be formulated in a liquid or solid composition before being coated onto a composition. For example, a solid composition comprising the spores can be prepared by mixing a solid carrier with a suspension of the spores until the solid carriers are impregnated with the spore or cell suspension. This mixture can then be dried to obtain the desired particles.

In some other embodiments, it is contemplated that the solid or liquid probiotic compositions of the present disclosure further contain functional agents e.g., activated carbon, minerals, vitamins, and other agents capable of improving the quality of the products or a combination thereof.

Methods of coating and compositions in use of said methods that are known in the art can be particularly useful when they are modified by the addition of one of the embodiments of the present disclosure. Such coating methods and apparatus for their application are disclosed in, for example: U.S. Pat. Nos. 8,097,245 and 7,998,502; and PCT Pat. App. Publication Nos. WO 2008/076975, WO 2010/138522, WO2011/094469, WO 2010/111347, and WO 2010/111565, each of which is incorporated by reference herein.

In some embodiments, the SFB spores of the present disclosure may be administered via drench. In one embodiment, the drench is an oral drench. A drench administration comprises utilizing a drench kit/applicator/syringe that injects/releases a liquid comprising the SFB spores into the buccal cavity and/or esophagus of the animal.

In some embodiments, the SFB spores of the present disclosure may be administered in a time-released fashion. The composition may be coated in a chemical composition, or may be contained in a mechanical device or capsule that releases the SFB spores over a period of time instead all at once. In one embodiment, the SFB spores are administered to an animal in a time-release capsule. In one embodiment, the composition may be coated in a chemical composition, or may be contained in a mechanical device or capsule that releases the SFB spores all at once a period of time hours post ingestion.

In some embodiments, the methods further comprise administering sodium bicarbonate prior to the probiotic composition to reduce pH and improve colonization.

### Inducing Resistance to Pathogens and Improving Gut Health

In some aspects, the present disclosure is drawn to administering one or more probiotic compositions described herein to poultry to induce resistance to pathogenic microbes. In some embodiments, the present disclosure is further drawn to administering probiotic compositions described herein to prevent colonization of pathogenic microbes in the gastrointestinal tract. The use of the probiotic compositions described herein for poultry result in reduced colonization of the gastrointestinal tracts of poultry by bacterial pathogens, including but not limited to Salmonella spp., Campylobacter spp., and Clostridium spp.

In some embodiments, the administration of probiotic compositions described herein reduce lower gut permeability and reduce microbial leakage from the gastrointestinal tract, further providing for a reduced risk of extraintestinal pathogens including for bacterial sepsis from pathogens like Escherichia coli.

Pathogenic microbes of poultry include the following: Mycoplasma gallisepticum, Mycoplasma meleagridis, Mycoplasma synoviae, Pasteurella multocida, Clostridium perfringens, Clostridium colinum, Clostridium botulinum, Salmonella typi, Salmonella typhimurium, Salmonella enterica, Salmonella pullorum, Salmonella gallinarum, Hemophilus gallinarum, Erysipelothrix insidiosa, Campylobacter jejuni, Campylobacter coli, Campylobacter lari, Listeria monocytogenes, Arcobacter butzleri, Mycobacterium avium, and pathogenic strains of Escherichia coli and Staphylococcus aureus. In some embodiments, the pathogenic microbes are pathogenic to both poultry and humans. In some embodiments, the pathogenic microbes are pathogenic to either poultry or humans.

In some embodiments, the administration of compositions of the present disclosure to poultry modulate the makeup of the gastrointestinal microbiome such that the administered microbes outcompete microbial pathogens present in the gastrointestinal tract. In some embodiments, the administration of compositions of the present disclosure to poultry harboring microbial pathogens outcompetes the pathogens and clears the poultry of the pathogens. In some embodiments, the administration of compositions of the present disclosure stimulates host immunity, and aids in clearance of the microbial pathogens. In some embodiments, the administration of compositions of the present disclosure to poultry improves food safety by preventing colonization of pathogenic microbes that are pathogenic to both poultry and humans.

In some embodiments, challenging poultry with a microbial colonizer or microbial pathogen after administering the probiotic composition of the present disclosure prevents the microbial colonizer or microbial pathogen from growing to a relative abundance of greater than 15%, 14%, 13%, 12%, 11%, 10%, 9%, 8%, 7%, 6%, 5%, 4%, 3%, 2%, 1%, 0.5%, 0.1%, or 0.01%. In further embodiments, challenging poultry with a microbial colonizer or microbial pathogen after administering the probiotic composition of the present disclosure prevents the microbial colonizer or microbial pathogen from colonizing poultry.

### Methods of SFB Spore Isolation

In some aspects, the present disclosure relates to methods of obtaining SFB spores from poultry. The methods comprise obtaining a small intestinal scraping sample from the poultry, treating the sample with chloroform, and isolating SFB spores from the chloroform treated sample. In some embodiments, the methods further comprise freezing the isolated SFB spore sample for long term storage.

In some embodiments, a sample is processed to detect the presence of SFB spores in the sample.

In one embodiment of processing the sample to detect the presence and number of SFB spores, a microscopy assay is employed. In one embodiment, the microscopy is transmission electron microscopy.

In another embodiment, the sample, or a portion thereof is subjected to a polymerase chain reaction (PCR) for detecting the presence and abundance of a marker. Any marker that is unique to an organism can be employed. For example, markers can include, but are not limited to, small subunit ribosomal RNA genes (16S/18S rDNA), large subunit ribosomal RNA genes (23S/25S/28S rDNA), intercalary 5.8S gene, cytochrome c oxidase, beta-tubulin, elongation factor, RNA polymerase and internal transcribed spacer (ITS). In one embodiment, the presence of SFB in the solution may be confirmed using the taxa-specific primers of SEQ ID NO: 1 and SEQ ID NO: 2.

The following examples are intended only to further illustrate the invention and are not intended to limit the scope of the subject matter which is defined by the claims.

### EXAMPLES

### Example 1: SFB Inoculum Preparation

Scrapings from the distal ileum and ceca tonsil of two-week-old commercial layer pullets were resuspended in phosphate-buffered saline (PBS) (3 mM EDTA) and treated with chloroform (3% total solution). Tubes were gently inverted, placed on ice, and then incubated for 30 min at 37° C. After a subsequent incubation for 10 min at room temperature (RT), the top layer (containing spores) was transferred to fresh microcentrifuge tubes and centrifuged at 10,000×g for 10 min. Supernatant was discarded and pellet (containing spores) was resuspended in a peptone-glycerol solution, purified through a 5 μm filter, and stored at −80° C. for 3 months prior to animal-inoculation. To test probiotic potential of SFB, we orally-inoculated newly hatched chicks with small intestinal scrapings with (iSFB) or without (CON) SFB. Intestinal scrapings prepared without chloroform treatment was used as a control.

### Example 2: Chloroform-Treated Small Intestinal Scrapings Enhanced SFB Identification and Induced Spore Formation

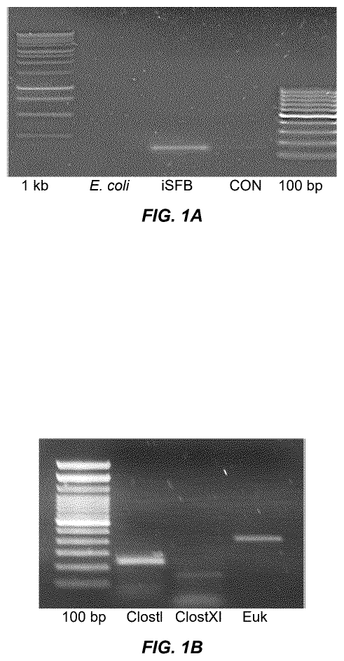

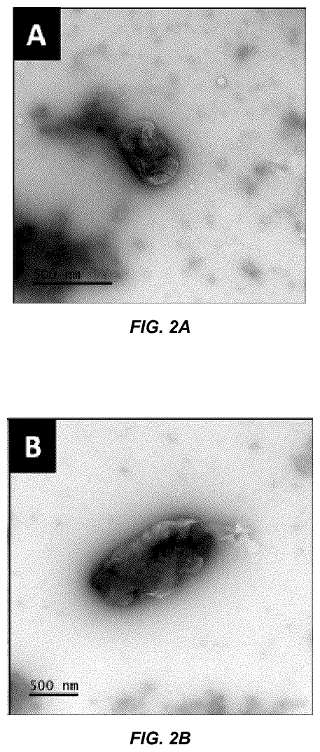

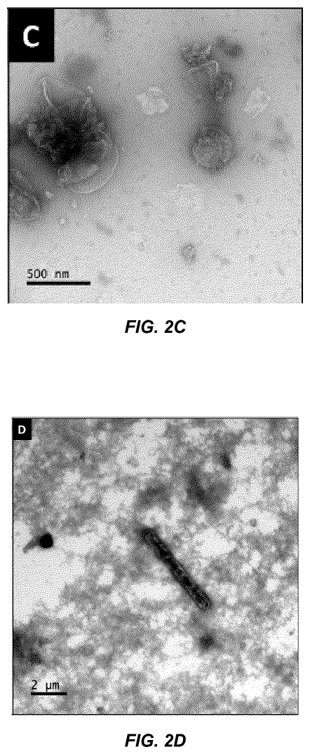

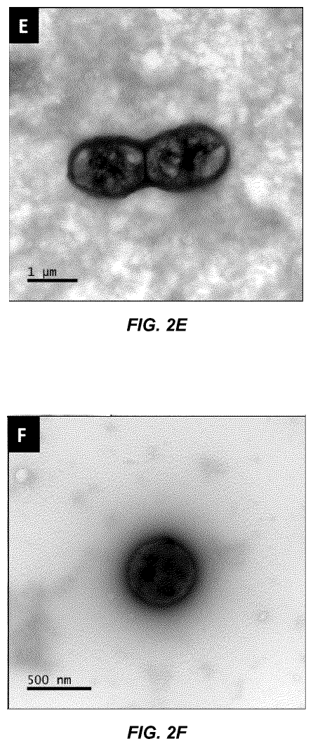

Using taxa-specific primers (TABLE 1), SFB were detected only in small intestinal scrapings pre-treated with chloroform (FIG. 1A). In iSFB inoculum, Clostridium clusters I and XI and eukaryotes were also detected (FIG. 1B). However, none of these non-SFB taxa were present in CON inoculum. Using TEM, no spores were detected in non-chloroform treated samples with bacterial cells exhibiting high levels of atrophy and death (FIG. 2A and FIG. 2B). When imaging chloroform-treated small intestinal scrapings, although cellular atrophy was still present (FIG. 2C), sporulation was widely observed (FIG. 2D-F).

TABLE 1

| Primer | |
|---|---|
| targets | Primer sequence (5′ → 3′) |
| SFB | F: AGGAGGAGTCTGCGGCACATTAGC (SEQ ID NO: 1) |
| | R: TCCCCACTGCTGCCTCCCGTAG (SEQ ID NO: 2) |
| ClostI | F: TACCHRAGGAGGAAGCCAC (SEQ ID NO: 3) |
| | R: GTTCTTCCTAATCTCTACGCAT (SEQ ID NO: 4) |
| ClostXI | F: ACGCTACTTGAGGAGGA (SEQ ID NO: 5) |
| | R: GAGCCGTAGCCTTTCACT (SEQ ID NO: 6) |
| Euk | F: CGGTAATTCCAGCTCCAAT (SEQ ID NO: 7) |
| | R: TCGATCCCCTAACTTTCGTT (SEQ ID NO: 8) |

SFB, segmented filamentous bacteria.
ClostI, Clostridium cluster I.
ClostXI, Clostridium cluster XI.
Euk, universal eukaryote

### Example 3: SFB Colonize Gut at Much-Earlier Age in iSFB Birds

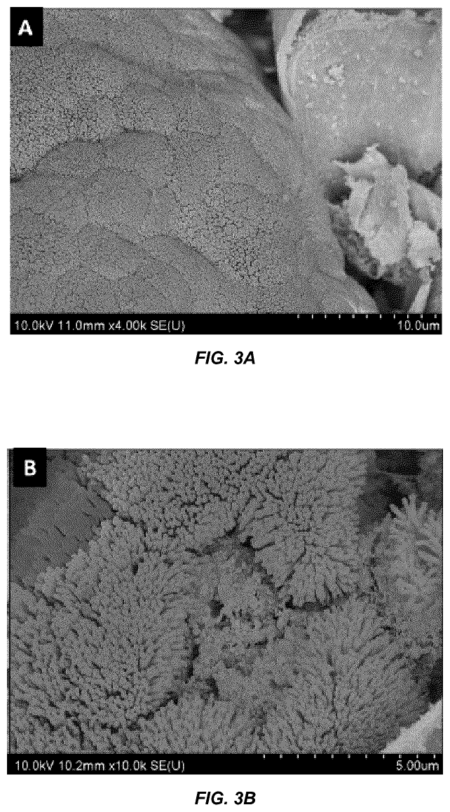

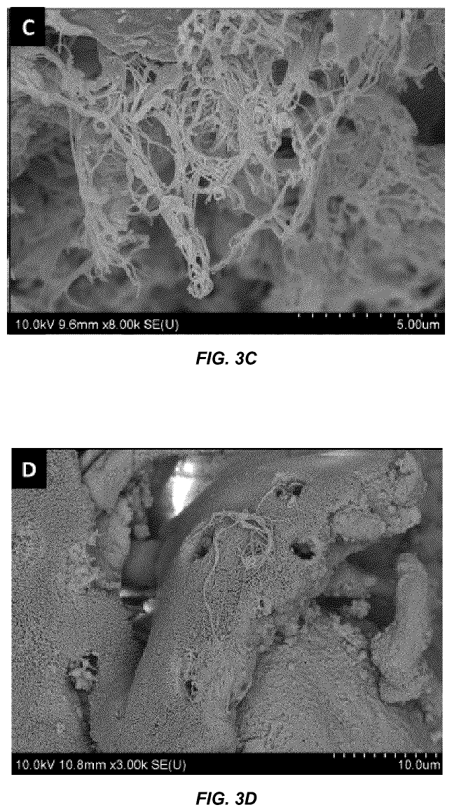

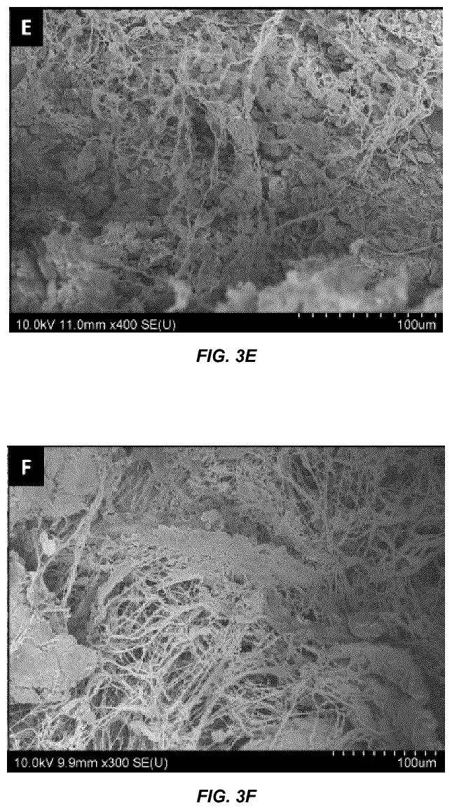

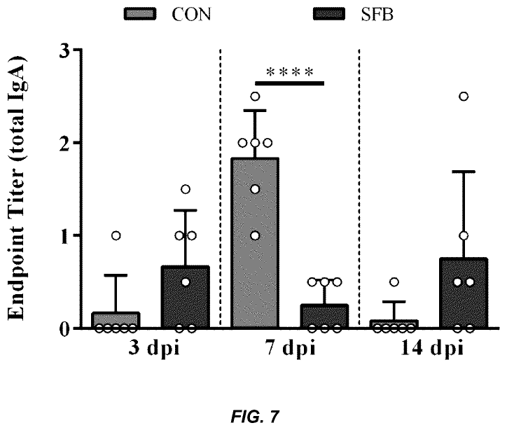

SFB colonization in distal ileum via SEM is summarized in TABLE 2, and representative images are shown in FIG. 3. In CON group, SFB filaments were absent in chicks at 3 (FIG. 3A) and 7 dpi (FIG. 3B) and detected at 14 dpi in 50% birds (FIG. 3C). However, in iSFB-treated group, SFB filaments were detected at 3 dpi in 50% of birds (FIG. 3D) and in all birds tested at 7 (FIG. 3E) and 14 dpi (FIG. 3F).

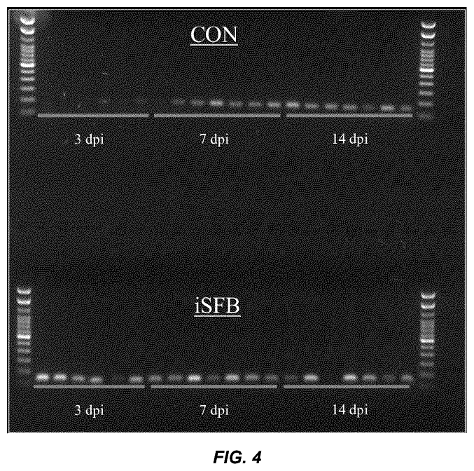

Using PCR, SFB were clearly-detected in the chicken ceca in all iSFB birds at 3 dpi, whereas CON birds did not exhibit consistent colonization at 3 dpi (FIG. 4). However, other taxa previously detected in the iSFB inoculum were detected similarly in both CON and iSFB birds at 3 dpi. No notable differences between any taxa were observed at 7 nor 14 dpi in CON and iSFB groups (FIG. 4).

TABLE 2

| | Proportion of birds SFB-positive | | |
|---|---|---|---|
| Group | 3 dpi | 7 dpi | 14 dpi |
| CON | 0/4 | 0/4 | 2/4 |
| iSFB | 2/4 | 4/4 | 4/4 |

CON, control birds given non-treated inoculum. iSFB, birds treated with chloroform-treated inoculum. dpi, days-post inoculation.

Using SEM, we observed SFB filaments in the distal ileum as early as 3 days post-inoculation in iSFB birds. Conversely, SFB filaments were not observed until 14 days in CON birds, which is within the time range SFB abundances peaked in previous reports in poultry animals. Earlier SFB-colonization in iSFB birds was further supported by PCR, as SFB were detected in every iSFB bird at 3 dpi. Thus, we demonstrate that oral inoculation with these spores 1) hastens SFB colonization and 2) improves consistency of SFB colonization between birds.

### Example 4: ISFB Birds had Reduced Weight Gain and Gut Permeability

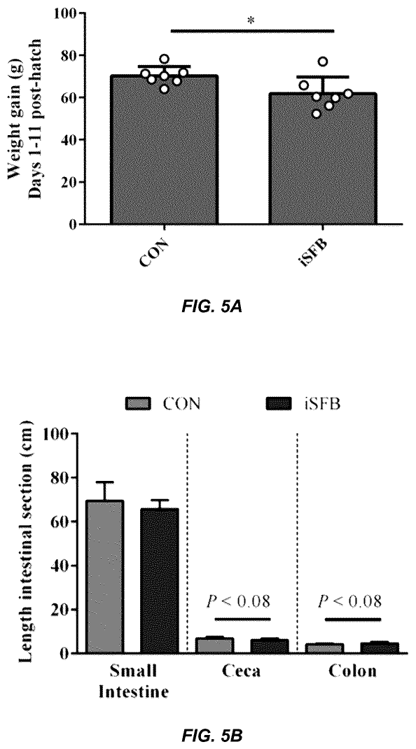

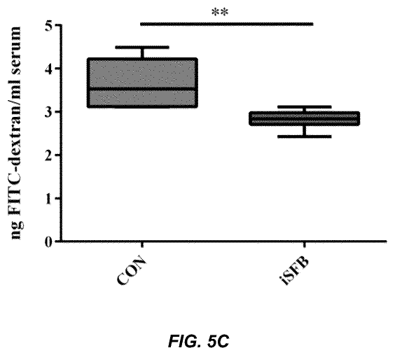

Tracking weights from 1 to 11 days post-hatch (FIG. 5A), iSFB birds had slightly-reduced weight gain versus CON birds (P<0.05). Measuring intestinal segment lengths 14 days post-treatment (FIG. 5B), small intestine length was similar between groups. Although not statistically-significant, CON ceca lengths were longer (P<0.08) than iSFB lengths, and iSFB colon lengths were longer (P<0.08) than CON lengths.

At days 3, 7, and 14 post-inoculation, birds (n=7 per time point) were orally inoculated with fluorescein isothiocyanate dextran (FITC-d, MW 3-5 kDa; 8.32 mg/kg chicken) 2 hours prior to sacrifice to measure gut permeability. Serum from all FITC-d-inoculated birds was collected via centrifugation and kept at 4° C. until ready to aliquot onto 96 well plates. A standard curve using serum from naïve birds serially-diluted for specific, added FITC-d concentrations (6,400 ng/ml to 0 ng/ml) was developed to normalize output. A spectrophotometer was used to measure FITC concentration at excitation wavelength of 485 nm and emission wavelength of 528 nm.

At 3 dpi, gut permeability was significantly reduced in iSFB versus CON birds (FIG. 5C; P<0.01), but no differences were seen 7 nor 14 dpi. Additionally, treatment did not affect inflammation (H&E) nor mucus thickness (Alcian blue) in the ceca tonsils of birds at any time point.

In this example, we find that iSFB birds exhibited lower gut permeability versus CON birds, suggesting these small intestinal spores reduce microbial leakage from the GI tract. Given this improvement was seen as early as 3 dpi, this treatment may reduce risks for bacterial sepsis from pathogens like extraintestinal Escherichia coli, a major cause of early mortality in chickens.

### Example 5: ISFB Small Intestinal Scrapings had Time-Dependent Changes in Salmonella Killing and was IgA Independent

To collect small intestinal scrapings, a 10-cm segment aligning Meckel's diverticulum in the center was longitudinally-cut, excess luminal contents were removed, and the epithelial layer was gently scraped and resuspended with 10 ml phosphate-buffered saline (PBS). Conicals were centrifuged at 5000×g for 20 minutes at 4° C., and 1 ml supernatant was added to 30 μl storage mixture (1% sodium azide, 5% BSA, 50 mM phenylmethane sulfonyl fluoride) before storage at −80° C.

To determine broad protection against Salmonella, several S. enterica strains (Table 3) were cultured on LB agar (0.1% glucose). Individual colonies were added to PBS until OD₆₀₀ reached 0.1, and this inoculum was diluted until 10² CFU/100 μl was reached. Small intestinal scrapings were pooled into two groups per treatment at each time point (A, n=4; B, n=3), and pooled washes were added to Salmonella inoculum at 1:1 ratio and incubated for 6 hours at 37° C. Solutions were then serially diluted and plated on MacConkey for bacterial enumeration.

TABLE 3

| Salmonella enterica | Isolation source/bank number; relevant antibiotic- |
|---|---|
| serovar | resistance profiles and/or characteristics |
| UK-1 (Typhimurium) | Highly-virulent “universal killer,” isolated from horse |
| Kentucky | Poultry-isolate; TC_{R}, ST_{R}, CP_{R}, ammonium-resistance |
| Albert | Bank number 0401; ST_{R}, TC_{R}, CP_{R}, CA_{R}, SU_{R}, AG_{R} |
| Heidelberg | Bank number 0404; CP_{R} |
| Typhimurium | Bank number 0408; ST_{R}, TC_{R}, CP_{R}, CA_{R}, SU_{R} |

TC, tetracycline. ST, streptomycin. CP, cephalosporin. CA, chloramphenicol. SU, sulfanomide. AG, aminoglycoside. Subscript “R” indicates resistance.

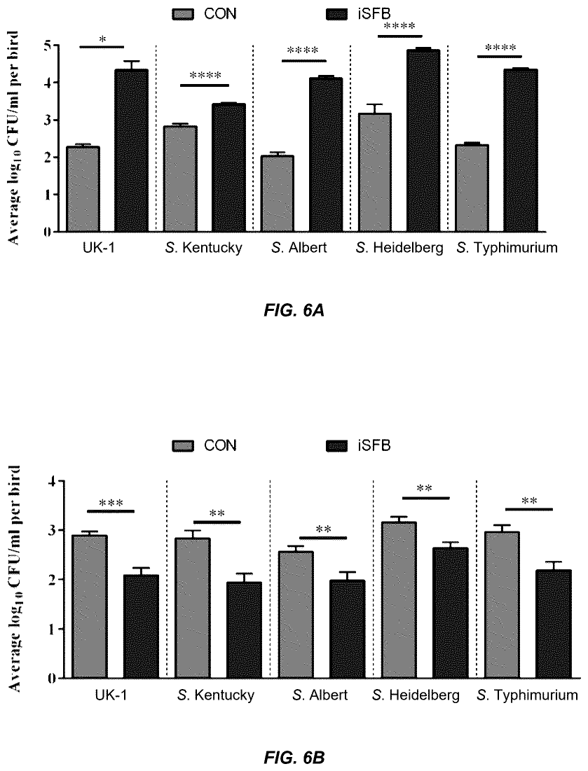

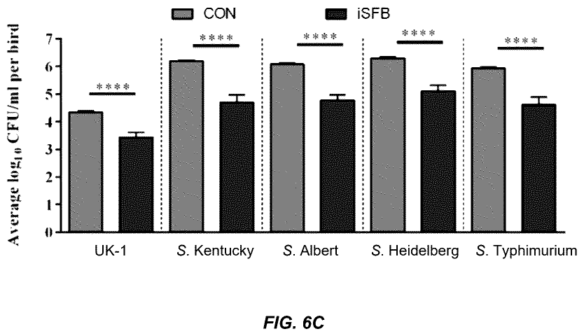

Using small intestinal scrapings to perform in vitro Salmonella-killing assays, iSFB small intestinal scrapings at 3 dpi (FIG. 6A) iSFB small intestinal scrapings were highly reduced in inhibiting growth of every S. enterica serovar tested versus CON (P<0.05). However, at 7 (FIG. 6B) and 14 (FIG. 6C) dpi, iSFB small intestinal scrapings had greater growth-suppression of all S. enterica serovars tested versus CON (P<0.05). Measuring total IgA in small intestinal scrapings at each time point (FIG. 7), endpoint titers were similar at 3 and 14 dpi between iSFB and CON birds. However, total IgA levels were greatly reduced at 7 dpi in iSFB compared to CON birds (P<0.0001).

### Example 6: Several Immune and Metabolic Pathways Upregulated 3 and 7 Dpi in iSFB Birds

Top 20 KEGG immune pathways (based on false discovery rate, FDR) upregulated by iSFB treatment are summarized for 3 and 7 dpi in Table 4. Of the top 20 KEGG immune pathways, 18 were upregulated by iSFB treatment between time points, including PI3K-Akt (3 dpi, P=7.73×10⁻³³; 7 dpi, P=1.75×10⁻²⁷), chemokine (3 dpi, P=3.71×10⁻²²; 7 dpi, P=4.11×10⁻²⁰), B cell receptor (3 dpi, P=6.10×10⁻²²; 7 dpi, P=2.39×10⁻¹⁹) and T cell receptor (3 dpi, P=2.7×10⁻²⁰; 7 dpi, P=1.89×10⁻²¹) pathways (Table 4). Generally, the numbers of phosphorylated protein targets in conserved KEGG pathways were greater at 3 versus 7 dpi, demonstrating more targets involved in these respective immune pathways are phosphorylated earlier in life. Some pathways were uniquely upregulated at specific time points in iSFB birds. At 3 dpi, endocytosis (P=2.15×10⁻¹²) and Th1/Th2 differentiation (P=2.86×10⁻⁸) pathways were upregulated, whereas TH17 cell differentiation (P=1.36×10⁻¹⁰) and necroptosis (P=5.50×10⁻⁶) pathways were uniquely upregulated in iSFB birds 7 dpi.

In addition, top 20 KEGG metabolic pathways (based on FDR) upregulated by iSFB treatment are summarized for 3 and 7 dpi in TABLE 5. In total, 17 KEGG metabolic pathways were upregulated by iSFB treatment at both 3 and 7 dpi, including insulin signaling (3 dpi, P=5.43×10⁻³¹; 7 dpi, P=3.72×10⁻²³), hypoxia-induced factor (HIF)-1 signaling (3 dpi, P=7.33×10⁻²⁶; 7 dpi, P=6.42×10⁻²⁴), AMP-activated protein kinase (AMPK) signaling (3 dpi, P=1.42×10⁻²²; 7 dpi, P=1.22×10⁻¹⁵), insulin resistance (3 dpi, P=1.25×10⁻²¹; 7 dpi, P=1.21×10⁻¹⁸), mammalian target of rapamycin (mTOR) signaling (3 dpi, P=1.78×10⁻²¹; 7 dpi, P=4.25×10⁻¹⁸) pathways. Similar to immune pathways, numbers of protein phosphorylation targets were generally lower at 7 dpi versus 3 dpi. Carbon metabolism (P=2.24×10⁻⁹), fatty acid metabolism (P=1.01×10⁻⁷), propanoate metabolism (P=6.58×10⁻⁷) pathways were specifically-upregulated in iSFB birds at 3 dpi only. However, phosphatidylinositol signaling system (P=0.00015), inositol phosphate metabolism (P=0.00018), and fatty acid biosynthesis (P=0.0016) pathways are uniquely-upregulated in iSFB at 7 dpi alone.

To determine similarities in kinome profiles (i.e., kinotypes) between treatment groups and time points, PIIKA2 was used to combine the biological replicates for each treatment and tissue, normalize the data, and generate a representative kinotype. The most similar distal ileum kinotypes were CON from 7 dpi and iSFB from 3 dpi. However, the kinotype of iSFB birds from 7 dpi was most unique, separating from the other three kinotypes.

TABLE 4 shows KEGG immune pathways enriched from unique peptides in iSFB (compared to CON) birds 3 and 7 days post-inoculation. Proteins statistically significantly differentially phosphorylated uniquely in the distal ileum from the iSFB group were pulled out of the array data and input into STRING for analysis. The top 20 immune pathways from each point are shown in this table. FDR, false-discovery rate.

TABLE 4

| | 3 dpi | | 7 dpi | |
|---|---|---|---|---|
| KEGG Pathway | # Proteins | p-value (FDR) | # Proteins | p-value (FDR) |
| PI3K-Akt signaling pathway | 56 | 7.73 10⁻³³ | 45 | 1.75 × 10⁻²⁷ |
| Chemokine signaling pathway | 34 | 3.71 × 10⁻²² | 29 | 4.11 × 10⁻²⁰ |
| B cell receptor signaling pathway | 25 | 6.10 × 10⁻²² | 21 | 2.39 × 10⁻¹⁹ |
| T cell receptor signaling pathway | 26 | 2.70 × 10⁻²⁰ | 25 | 1.89 × 10⁻²¹ |
| Autophagy | 28 | 3.03 × 10²⁰ | 23 | 2.01 × 10⁻¹⁷ |
| Fc epsilon RI signaling pathway | 22 | 4.95 × 10⁻¹⁹ | 20 | 1.21 × 10⁻¹⁸ |
| Toll-like receptor signaling | 25 | 5.62 × 10⁻¹⁹ | 18 | 1.15 × 10⁻¹³ |
| pathway | | | | |
| Fc-gamma R-mediated | 22 | 6.25 × 10⁻¹⁷ | 18 | 1.56 × 10⁻¹⁴ |
| phagocytosis | | | | |
| Natural killer cell mediated | 24 | 2.46 × 10⁻¹⁶ | 19 | 2.05 × 10⁻¹³ |
| cytotoxicity | | | | |
| Apoptosis | 23 | 1.09 × 10⁻¹⁴ | 20 | 8.23 × 10⁻¹³ |
| TNF signaling pathway | 21 | 1.74 × 10⁻¹⁴ | 22 | 1.70 × 10⁻¹⁷ |
| JAK-STAT signaling pathway | 24 | 3.12 × 10⁻¹⁴ | 21 | 1.51 × 10⁻¹³ |
| IL-17 signaling pathway | 18 | 1.28 × 10⁻¹² | 12 | 3.62 × 10⁻⁸ |
| Endocytosis | 26 | 2.15 × 10⁻¹² | | NS |
| Leukocyte transendothelial | 19 | 2.61 × 10⁻¹² | 15 | 4.26 × 10⁻¹⁰ |
| migration | | | | |
| Inflammation mediator regulation | 16 | 1.13 × 10⁻¹⁰ | 14 | 3.92 × 10⁻¹⁰ |
| of TRP channels | | | | |
| Th17 cell differentiation | | NS | 15 | 1.36 × 10⁻¹⁰ |
| NF-κB signaling pathway | 15 | 1.13 × 10⁻⁹ | 15 | 4.30 × 10⁻¹⁰ |
| Wnt signaling pathway | 17 | 4.96 × 10⁻⁹ | 13 | 4.14 × 10⁻⁷ |
| NOD-like receptor signaling | 17 | 3.69 × 10⁻⁸ | 12 | 1.04 × 10⁻⁵ |
| pathway | | | | |
| Th1 and Th2 differentiation | 12 | 2.86 × 10⁻⁸ | | NS |
| Necroptosis | | NS | 12 | 5.50 × 10⁻⁶ |

TABLE 5 shows KEGG metabolic pathways enriched from unique peptides in iSFB (compared to CON) birds 3 and 7 days post-inoculation. Proteins statistically significantly differentially phosphorylated uniquely in the distal ileum from the iSFB group were pulled out of the array data and input into STRING for analysis. The top 20 metabolic pathways from each point are shown in this table. FDR, false-discovery rate.

TABLE 5

| | 3 dpi | | 7 dpi | |
|---|---|---|---|---|
| KEGG Pathway | # Proteins | p-value (FDR) | # Proteins | p-value (FDR) |
| Insulin signaling | 39 | 5.43 × 10⁻³¹ | 29 | 3.72 × 10⁻²³ |
| HIF-1 signaling pathway | 31 | 7.33 × 10⁻²⁶ | 27 | 6.42 × 10⁻²⁴ |
| AMPK signaling pathway | 30 | 1.42 × 10⁻²² | 21 | 1.22 × 10⁻¹⁵ |
| Insulin resistance | 28 | 1.25 × 10⁻²¹ | 23 | 1.21 × 10⁻¹⁸ |
| mTOR signaling pathway | 31 | 1.78 × 10⁻²¹ | 25 | 4.25 × 10⁻¹⁸ |
| Glucagon signaling pathway | 22 | 4.78 × 10⁻¹⁶ | 16 | 1.04 × 10⁻¹¹ |
| cAMP signaling pathway | 23 | 9.38 × 10⁻¹² | 20 | 3.30 × 10⁻¹¹ |
| Glycolysis/gluconeogenesis | 14 | 2.66 × 10⁻¹⁰ | 10 | 2.00 × 10⁻⁷ |
| Carbon metabolism | 16 | 2.24 × 10⁻⁹ | | NS |
| cGMP-PKG signaling pathway | 18 | 3.81 × 10⁻⁹ | 15 | 3.52 × 10⁻⁸ |
| Fatty acid metabolism | 10 | 1.01 × 10⁻⁷ | | NS |
| Calcium signaling pathway | 17 | 1.01 × 10⁻⁷ | 10 | 0.00041 |
| PPAR signaling pathway | 11 | 3.41 × 10⁻⁷ | 9 | 2.88 × 10⁻⁶ |
| Propanoate metabolism | 8 | 6.58 × 10⁻⁷ | | NS |
| Starch and sucrose metabolism | 8 | 7.88 × 10⁻⁷ | 4 | 0.0023 |
| Fatty acid degradation | 8 | 4.91 × 10⁻⁶ | 6 | 9.98 × 10⁻⁵ |
| Galactose metabolism | 7 | 6.00 × 10⁻⁶ | 4 | 0.0019 |
| Fructose and mannose metabolism | 7 | 8.54 × 10⁻⁶ | 4 | 0.0023 |
| Carbohydrate absorption and | 7 | 3.30 × 10⁻⁵ | 7 | 7.81 × 10⁻⁶ |
| digestion | | | | |
| Biosynthesis of amino acids | 9 | 1.79 × 10⁻⁵ | 7 | 0.00016 |
| Phosphatidylinositol signaling | | NS | 8 | 0.00015 |
| system | | | | |
| Inositol phosphate metabolism | | NS | 7 | 0.00018 |
| Fatty acid biosynthesis | | NS | 3 | 0.0016 |

This example demonstrates a broad upregulation of numerous immunometabolic pathways in iSFB birds. The nutrient-sensing pathways mTOR and insulin are closely-tied to immune processes and cellular differentiation. The protein mTOR is a PI3K-related kinase incorporated into two protein complexes, mTOR1 and mTOR2. These complexes are important in regulating nutrient and endocrine signals (mTOR1) as well as proliferation and survival (mTOR2). However, the most important role for mTOR2 is the activation of Akt, the key effector in insulin/PI3K signaling. We identified increased phosphorylation of several enzymes along mTOR, insulin, and PI3K/Akt signaling pathways at both 3 and 7 dpi in iSFB birds. All of these pathways have been previously reported to interact with the gut microbiota, suggesting the microbes in the iSFB inoculum are driving these responses. Furthermore, there was a consistent trend in which total pathway targets of protein phosphorylation were reduced from 3 to 7 dpi among these and other immunometabolic pathways reported in this study.

1.-20. (canceled)

21. A method of stimulating the immune system, and reducing gut permeability/microbial leakage in a chicken, the method comprising:
administering to the chicken an effective amount of a composition comprising viable spores of a segmented filamentous bacteria (SFB) obtained from a chloroform-treated small intestinal scraping of a chicken donor,
wherein the probiotic composition is administered within 24 hours of hatching, and
wherein the chicken has reduced gut permeability, through an activated T cell receptor signaling pathway, a B cell receptor signaling pathway, a Th17 cell differentiation pathway, a Toll-like receptor signaling pathway, an IL-17 signaling pathway, and an NF-κB signaling pathway in comparison to a chicken not administered the probiotic composition.

22. The method of claim 21, wherein the effective amount comprises from about 50 to about 100 spores.

23. The method of claim 21, wherein the composition is a single-use composition that exerts beneficial effects for at least 14 days.

24. The method of claim 21, wherein said effects are obtained without administration of an antibiotic to the chicken.

25. The method of claim 21, wherein the reduced gut permeability reduces the incidence of bacterial sepsis in a population of chickens where one or more chickens are treated.

26. The method of claim 21 wherein said effect is observed in 3 days post inoculation.

27. A method of increasing beneficial segmented filamentous bacteria (SFB) colonization in a chicken, the method comprising:
administering to the chicken an effective amount of a probiotic composition comprising viable cultured spores of SFB obtained from a chloroform-treated small intestinal scraping of a chicken donor,
wherein the probiotic composition is administered within 24 hours of hatching, and
wherein the chicken exhibits SFB colonization in the distal ileum by 7 days post-administration.

28. The method of claim 27, wherein the chicken exhibits SFB colonization in the distal ileum by 3 days post-administration.

29. The method of claim 27, wherein the effective amount comprises from about 50 to about 100 spores.

30. The method of claim 27, wherein the probiotic composition is a single-use probiotic.

31. The method of claim 27, wherein the method improves consistency of SFB colonization between chickens.

32. A method of inhibiting growth of Salmonella present in the intestine of a chicken without antibiotics, the method comprising:
administering to the chicken an effective amount of a composition comprising viable spores of a segmented filamentous bacteria (SFB) obtained from a chloroform-treated small intestinal scraping of a chicken donor.

33. The method of claim 32, wherein the effective amount comprises from about 50 to about 100 spores.

34. The method of claim 32, wherein the probiotic composition is a single-use composition.

35. The method of claim 32 wherein said Salmonella species is Salmonella. Enterica.

36. The method of claim 32 wherein the average spread of Salmonella in a population of chickens is decreased after treatment of a subset of chickens from said population.

37. A method of preparing a composition for reducing gut permeability and infectious microbial leakage from the intestine of chickens, the method comprising:
obtaining a small intestinal scraping sample from a chicken donor, wherein the small intestinal scraping sample is obtained from the distal ileum or ceca tonsil of the chicken donor;
treating the sample with chloroform at about 3% of total solution;
isolating segmented filamentous bacteria (SFB) spores from the chloroform-treated sample; and
storing the isolated SFB spores at about −80° C.,
wherein the isolated SFB spores remain viable after storage.

38. The method of claim 37, wherein the isolated SFB spores are resuspended in a peptone-glycerol solution prior to storage.

39. The method of claim 37, wherein the isolated SFB spores are purified through a 5 μm filter prior to storage.

40. The method of claim 37, further comprising thawing the stored SFB spores prior to administration to a chicken.

41. The method of claim 37, wherein the SFB spores are stored for at least 3 months prior to administration.
